(19) United States
(12) Patent Application Publication
(10) Pub. No.: US 2019/0091862 A1
(43) Pub. Date: Mar. 28, 2019

(54) MOVABLE ROBAT IN CONSTRUCTION INDUSTRIES

(71) Applicant: Shahram RASHVAND, Markham (CA)

(72) Inventor: Shahram RASHVAND, Markham (CA)

(21) Appl. No.: 15/716,636

(22) Filed: Sep. 27, 2017

(51) Int. Cl. B25J 9/16; B25J 9/04; B25J 9/00; G05B 19/04

(52) U.S. Cl. CPC B25J 9/1674; B25J 9/1694; G05B 19/04; B25J 9/0009; B25J 9/04

(57) ABSTRACT

The present invention is a movable robot to perform multiple tasks in a real estate construction development, the movable robot comprises a station; a movable; a processor to execute, model and combine a layout of the construction area; a user interface to receive data into a data-storage for storing layouts and instructions; a communication means to communicate with a server and other the movable robot to dynamically report the progress of the instruction, location of the movable robot and a list of future tasks; a scanning system mounted on the station to scan and to overlap the layout on the construction area; a finder system to determine a path and an x-y-z location of a target on the construction area; a movement control system to move the movable robot along the path, and a battery pack to provide power for the movable robot.

### FIELD OF THE INVENTION

The present invention relates in general to robots and in specific to robots for performing a set of tasks for building construction.

### BACKGROUND OF THE INVENTION

Construction industry is one of the leading industries in the world. Builders and developers have been trying to minimize human errors in the workplace by several methods. In high rise buildings, the project managers ensure projects are done in a proper order to minimize waiting times for each task, and to complete the project on time and within the budget. The miscommunication between different trades can cause financial loss for the real estate developers and also delays the projects.

All builders/developers and project managers try to reduce the cost of development by introducing modern methods into the construction industry. The communication between different trades and project managers are done through effective applications, mainly visual, to manage projects with ease.

During the construction of a high rise building, the architectural details, electrical details and mechanical details are designed by engineers in different layout. Each trade is responsible to carry out different tasks for the specific details. The architectural, electrical and mechanical details are related in construction development based on a specific rules and concepts. It is crucial that all tasks are managed and performed properly. If one task is wrongfully done by a trade in the building, it can be very costly to solve the issue.

Therefore, it is desirable to have a device to manage all architectural, electrical and mechanical tasks in one place, realizing their interconnectivity, thereby minimizing potential performance errors.

### SUMMARY OF THE INVENTION

The present invention provides a device to precisely help on site project managers to co-ordinate between different trades in a construction project based on the plans specification prepared by designers/engineers.

The present invention is a movable robot. The movable robot comprises of a station, which has a top portion and a bottom portion with at least two wheels to move around a construction area, and a movable (we need to talk about it on the sketch please) arm comprising of a base connected to the top portion, and a first arm rotationally coupled to the base; a second arm pivotally coupled to the first arm; a third arm attached to the second arm; a fourth arm having a movable portion coupled to the third arm, the movable portion having an attachment clamp for attachment a tools, and a plurality of motor drive systems to provide movement for the first arm, the second arm, the third arm and the fourth arm.

The present invention further comprises of a processor to execute, model and combine at least a layout of the construction area for at least an instruction and generates a portfolio based on the layout and the instruction and a user interface to receive data into a data-storage for storing layouts and instructions. The present invention is able to mark pre-designed drawings and symbols on floor and construction sites exactly based on plans has been prepared by architect/engineers in AutoCAD/Revit.

The present invention is able to communicate with the server on the site or with the office through internet to upload the latest version and most updated design drawings to mark on the floor and perform the task. The present invention comprises of a communication means to communicate with a server and other the movable robot to dynamically report the progress of the instruction, location of the movable robot and a list of future tasks; a scanning system mounted on the station to scan and to overlap the layout on the construction area; a finder system to determine a path and an x-y location of a target on the construction area; a movement control system to move the movable robot along the path, and a battery pack to provide power for the movable robot.

The first objective of the present invention is to provide a device to enhance construction methods and speed up performing construction projects.

The second objective of the present invention is to provide a device to help project managers, engineers, and different traders to be more accurate, more precise and more related to each other on site.

The third objective of the present invention is to provide a device to minimize human errors in a construction job sites.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows a perspective view of the present invention;

FIG. 2 shows a schematic diagram of the present invention, and

FIG. 3 shows a bottom view of the present invention.

The figures are not intended to be exhaustive or to limit the present invention to the precise form disclosed. It should be understood that the invention can be practiced with modification and alteration, and that the disclosed technology be limited only by the claims and equivalents thereof.

### DETAILED DESCRIPTION OF PREFERRED EMBODIMENTS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

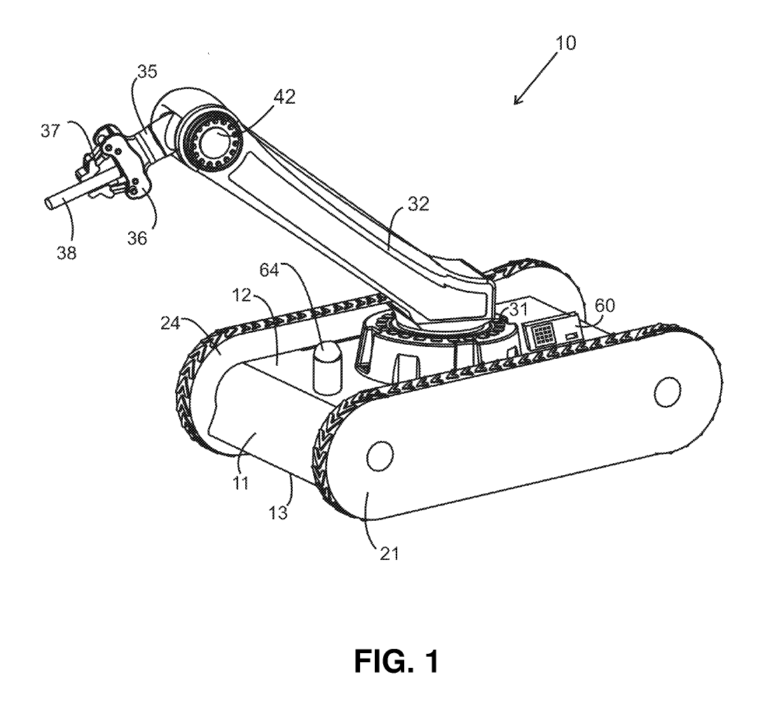

FIG. 1 shows a movable robot 10 to perform multiple tasks in a construction development. For example, the movable robot 10 can mark the location of lighting from lighting plan and power outlet (location of sockets and wiring) for each floor.

Again as shown in FIG. 1, the movable robot 10 comprises of a station 11 which has a top portion 12 and a bottom portion 13 with at least two wheels 21, 24 to move around a construction area. The movement of the wheels 21, 24 is traced by a program to keep record of the movement of the movable robot 10. The shape and the size of the wheels 21, 24 can be different based on variable task in a construction project.

The movable robot 10 also has a first arm 32, which comprises of a base 31 connected to the top portion 12, and a second arm 35 rotationally coupled to the first arm 32; and the second arm 35 having a movable portion 36 coupled to the first arm 32, the movable portion 36 having an attachment clamp 37 for attachment a tools 38, and a plurality of motor drive systems 31, 42 to provide movement for the first arm 32, and the second arm 35.

The tools in the movable robot 10 of the present invention are selected from the groups consisting of a brush, a marker, a spray to draw a mark, an arrow or a symbol in a floor or a wall of the job site.

The movable robot 10 of the present invention can mark and highlight the location of the drywalls in the architectural map and divide the floor to the individual units.

In another embodiment, the present invention can move around the job site (floor) and prepare a report for the upcoming project. For example, if some unnecessary equipment is in the floor which some trades want to perform a task in the location of the current equipment; the movable robot 10 can mark the equipment and find a proper location for the equipment. The present invention also tracks the changes in the location of the equipment and prepares a report to the engineers and project managers in the job site.

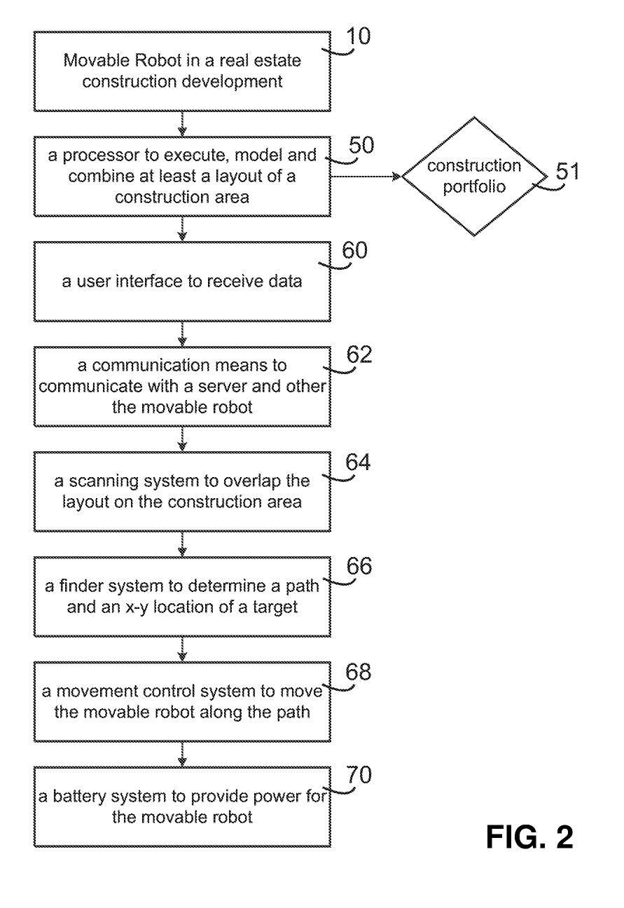

As shown in FIG. 2, the present invention 10 further comprises of a processor 50 to execute, model and combine at least a layout of the construction area for at least an instruction and generates a portfolio 51 based on the layout and the instruction and a user interface 60 to receive data into a data-storage for storing layouts and instructions.

Again as shown in FIG. 2, the present invention 10 further comprises a communication means 62 to communicate with a server and other the movable robot to dynamically report the progress of the instruction, location of the movable robot and a list of future tasks.

Again as shown in FIG. 2, the present invention 10 further comprises a scanning system 64 mounted on the station to scan and to overlap the layout on the construction area.

Again as shown in FIG. 2, the present invention 10 further comprises a finder system 66 to determine a path and an x-y location of a target on the construction area; a movement control system 68 to move the movable robot along the path, and a battery system 70 to provide power for the movable robot.

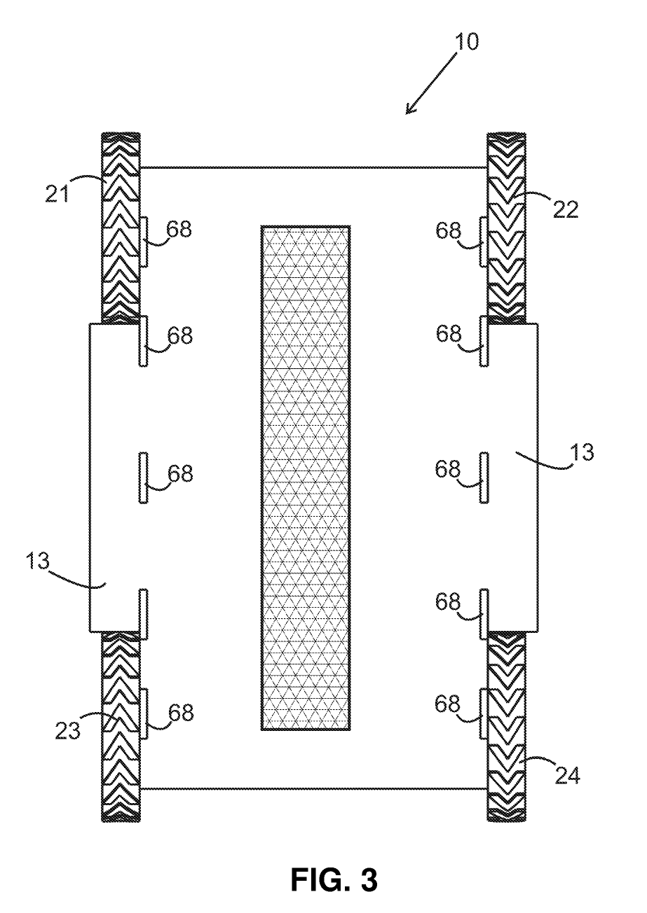

FIG. 3 shows a bottom view 13 of the present invention 10. As shown in FIG. 3, the movement control system 68, which are designed on the bottom portion 13 of the present invention 10, to control the movement of the movable robot along a path. The movement control system actively controls and registers the location of the robot 10 and makes sure the robot 10 correctly follows the path to reach to a target.

Again as shown in FIG. 3, a marker placement 80 is designed at the bottom portion 13 of the present invention 10 to draw a line with different colours in a floor to determine specific boundaries on the floor based on the information from the plan layouts.

For indoor navigation, a map of floor layout is used in which a movable robot is currently located. However, the map of floor layout alone is not sufficient. To aid the movable robot to navigate from one point to another, a plurality of information from different plan layouts may be used.

To initialize the process, the movable robot is located in a known location (x₁, y₁) in one of the layouts by the user. The known location can be an entrance of the floor or any location which is mentioned in the layouts. The movable robot saves the known location and sets the coordinates.

The movement of the movable robot is calculated by the processor. The processor executes the locations of the architectural, mechanical and electrical elements based on the different layouts with different scales and prepares the portfolio for the movable robot. The processor also checks the location of all elements and if there is an error on the layouts; it notifies the user.

An architectural map in a condominium development comprises of a plurality of information such as a site plan to indicate location of the building, a site statics to verify area of each floor, a fire separation plan to verify a fire wall, a plan to verify layout of each floors, a roof plan for layout of the roof, a building section, a building elevation to make view of external face of building, doors and windows schedule to verify dimension and type of windows and doors, and an enlarged plan to make enlarged plan for some spaces such as toilet room.

A structural map in a condominium development comprises of a plurality of information such as general notes to verify some specification materials, construction and regular, typical details to verify some structural details, a foundation plan, a framing plan, and column and wall schedule to verify foundation.

A mechanical map in a condominium development comprises of a plurality of information such as plumbing piping plan for domestic water, sanitary and storm piping plan, HVAC and piping system plan to verify ducting, piping and layout of each equipment in each floor, a fire protection, a riser diagram to show riser of each system, a schematic drawings and an equipment schedule to show specification of each equipment.

An electrical map in a condominium development comprises of a plurality of information such as lighting for lighting plan for each floor, power and system to show the location of sockets and wiring for each system, fire alarm, mechanical equipment power, a single riser diagram and a schedule to show specification of each equipment.

The combination and superimpose of these maps and layouts for each floor is time consuming and the persons and trades should have access to all the details of the maps and layouts at the time of doing a project.

The present invention can combine and superimpose all the maps and layouts for each floor and prepare a customized construction portfolio for the specific layout and mark the specific location for the upcoming project to facilitate the project for the trades.

The construction portfolio can be prepared indifferent computer software or mobile applications. The movable robot of the present invention moves, acts and performs the task based on the construction portfolio.

To facilitate the understanding of details of each layout, the present invention can draw a specific symbol with a color for each map. For example, the present invention can be programmed to draw blue lines for electrical map based on the users or codes preferences.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A movable robot to perform multiple tasks in a building construction, the movable robot comprises:
a) a station having a top portion and a bottom portion with at least two wheels to move around a construction area;
b) a movable arm comprising of:
i) a base connected to the top portion;
ii) a first arm rotationally coupled to the base, a second arm pivotally coupled to the first arm, a third arm attached to the second arm, and a fourth arm having a movable portion coupled to the third arm, the movable portion having an attachment clamp for attachment to a spray;
iii) a motor drive system to provide movement for said first arm, said second arm, said third arm, and said fourth arm;
c) a processor to execute, model, and combine at least a layout of the construction area for at least an instruction, and to generate a portfolio based on the layout and the instruction;
d) a user interface to receive data into a data-storage for storing layouts and instructions;
e) a communication means to communicate with a server and orders the movable robot to dynamically report the progress of the instruction, location of the movable robot and a list of future tasks;
f) a scanning system mounted on the station to scan and to overlap the layout on the construction area;
g) a finder system to determine a path and an x-y location of a target on the construction area;
h) a movement control system to move the movable robot along the path, and
i) a battery pack to provide power for the movable robot.

2. The movable robot of claim 1, wherein said wheels have variable shapes to move in variable surfaces on said building construction.

3. The movable robot of claim 1, wherein said wheels have variable sizes.

4. The movable robot of claim 1, wherein said movable robot further has a marker placement designed at said bottom portion to draw a line with different colours in a floor to determine specific boundaries on said floor.

5. The movable robot of claim 1, wherein said tools being selected from the groups consisting of a brush, a marker, a spray to draw a mark, an arrow or a symbol.

6. The movable robot of claim 1, wherein said portfolio comprises of a plurality of locations of architectural, mechanical and electrical elements and the path to reach to the elements.
